(19) United States
(12) Patent Application Publication
(10) Pub. No.: US 2004/0056980 A1
(43) Pub. Date: Mar. 25, 2004

(54) Television receiver

(76) Inventors: Machiko Miyagawa, Takefu-shi (JP); Yashinori Mizushima, Takefu-shi (JP)

Correspondence Address: REED SMITH LLP, Suite 1400, 3110 Fairview Park Drive, Falls Church, VA, 22042, US

(21) Appl. No.: 10/639,624

(22) Filed: Aug. 13, 2003

(30) Foreign Application Priority Data
Aug. 13, 2002 (JP) 2002-236027

(51) Int. Cl. H04N 5/63; H04N 5/44

(52) U.S. Cl. 348/553; 348/730

(57) ABSTRACT

A schedule is reliably reported at a scheduled time. Information such as a date, a work and the like of a schedule is input through a remote controller. It is monitored whether a set scheduled time comes or not. When the scheduled time comes, an alarm is turned ON to produce a sound from a speaker, thereby drawing a user's attention. An icon representing the work is displayed on a screen projecting a video. After the user carries out an operation for an OFF instruction or one minute passes, the alarm is turned OFF and the display of the icon is ended.

### BACKGROUND OF THE INVENTION

1. Field of the Invention

The present invention relates to a television receiver having a schedule managing function.

2. Prior Art

A television receiver having a function of displaying an input schedule on a screen has been proposed in Japanese Patent Applications laid open under Nos. 9-37176, 9-37177, 8-298628 and 7-23306, for example.

In the conventional television receiver, information about a schedule is displayed by a method of synthesizing and displaying the information images of the schedule or displaying the information about the schedule on a picture-in-picture screen when projecting the video of a program onto a screen.

In some cases in which the image of the schedule is displayed unremarkably when the video of the program is being viewed, however, a user does not become aware of the said image. To the contrary, in some cases in which the image is displayed on the picture-in-picture screen in such a manner that the user always becomes aware of the said image, an original video becomes incomplete so that the user feels uncomfortable. When the power supply of the television receiver is OFF, moreover, the schedule cannot be displayed on the screen even if a scheduled time comes.

### SUMMARY OF THE INVENTION

Therefore, it is an object of the present invention to provide a television receiver capable of reliably reporting a schedule in consideration of the foregoing.

In order to attain the object, the present invention provides a television receiver comprising input means for inputting a schedule, alarm setting means for setting ON/OFF of an alarm, display means for displaying information about the schedule at a scheduled time, and reporting means for carrying out a report by the alarm at the scheduled time when the alarm is ON.

Consequently, the schedule is displayed punctually and a report is carried out by the alarm to appeal to ears as well as eyes. Even if a user does not become aware of the display on a screen, a user becomes aware of a sound, therefore, a user can reliably know the schedule. It is also applicable that the alarm stimulates the sense of touch and the sense of smell instead of stimulating the sense of hearing to draw the user's attention.

Moreover, a power supply is not always turned ON. In this case, it is preferable to provide starting means for turning ON the power supply when the power supply is OFF at a scheduled time. Even if the power supply is OFF, it can be automatically turned ON to report the schedule.

When the power supply is OFF, there is a high possibility that the user might be absent. If the power supply is maintained to be ON, a power is wastefully consumed. Therefore, there is provided ending means for turning OFF the power supply when a predetermined time passes after the power supply is turned ON. Consequently, the power supply is automatically turned OFF when the user is absent.

When the user is present, an input is carried out by some operation. For this reason, it is preferable to provide continuing means for switching over to a normal operation when some input is carried out within a predetermined time after the power supply is turned ON. The power supply is successively maintained to be ON and can be prevented from being turned OFF in spite of the user's presence.

Moreover, there is provided timer means for carrying out timing after the input of a schedule. When a time set at the time of the input of the schedule passes, the information about the schedule is displayed and reported by the alarm. Consequently, the schedule can be reported by utilizing the timer function of the television receiver and a complicated operation does not need to be performed.

### BRIEF DESCRIPTION OF THE DRAWINGS

FIG. 1 is a schematic block diagram showing a television receiver according to an embodiment of the present invention,

FIG. 2 is a flow chart showing the input of a schedule,

FIG. 3 is a diagram showing a menu screen obtained when the schedule is input,

FIG. 4 is a diagram showing a schedule set screen,

FIG. 5 is a diagram showing a screen obtained when the schedule is decided,

FIG. 6 is a flow chart showing the output of the schedule,

FIG. 7 is a view showing a television receiver on which the work of the schedule is displayed,

FIG. 8 is a flow chart showing the output of the schedule when a power supply is turned OFF, and

FIG. 9 is a diagram showing the simple set screen of the schedule.

### DESCRIPTION OF THE PREFERRED EMBODIMENT

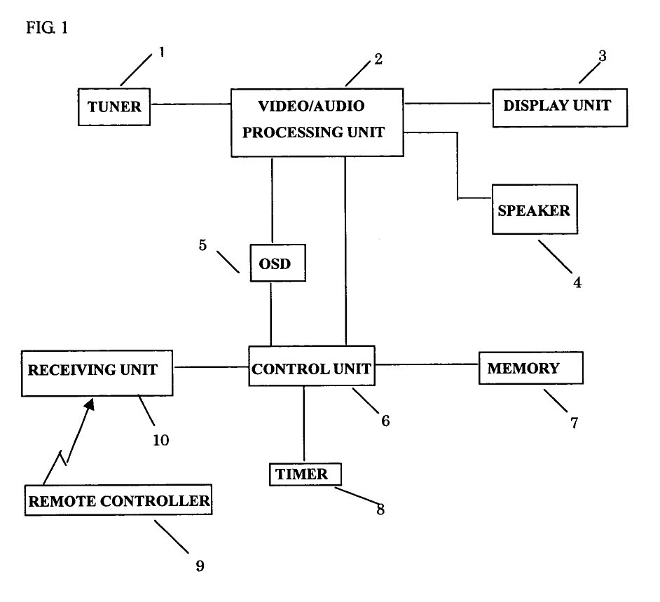

FIG. 1 shows a television receiver according to an embodiment of the present invention. 1 denotes a tuner, 2 denotes a video and audio processing unit, 3 denotes a display unit such as a CRT or a liquid crystal display, 4 denotes a speaker, 5 denotes an OSD (On Screen Display) unit, 6 denotes a control unit, 7 denotes a memory, 8 denotes a timer, 9 denotes a remote controller, and 10 denotes a receiving unit.

In the television receiver, a receiving signal sent from terrestrial broadcasting or satellite broadcasting is input to the tuner 1. The tuner 1 selects the receiving signal of a selected channel and outputs the same receiving signal to the video and audio processing unit 2. The video and audio processing unit 2 extracts a video signal and a voice signal from the receiving signal and carries out predetermined processings respectively, and outputs the signals thus processed to the display unit 3 and the speaker 4. The OSD unit 5 generates an image signal based on display information sent from the control unit 6 and outputs the image signal to the video and audio processing unit 2. The image signal is synthesized with the video signal to be displayed or is displayed as it is. The control unit 6 generally controls each section based on a signal input from the remote controller 9.

The control unit 6 has a schedule managing function. The control unit 6 saves a schedule input from input means in a memory and controls the video and audio processing unit 2 and the OSD unit 5 to display information about the schedule and to carry out a report to cause the user to become aware thereof when the scheduled time comes. Moreover, the control unit 6 has the function of turning ON/OFF a power supply, and turns ON the power supply when the power supply is OFF and the scheduled time comes. Furthermore, the control unit 6 automatically turns OFF the power supply after a predetermined time passes. When the power supply is OFF, a power plug is connected to a receptacle so that a power is supplied to the control unit 6 and the timer 8 outputs a current time, and the display unit 3 and the speaker 4 are not driven. The control unit 6 also has the function of displaying the information about the schedule and carrying out a report to cause the user to become aware thereof by utilizing the timer 8 when a set time passes after the input of the schedule.

Items to be set as the schedule include a date, a time, a work, a user's name and presence of an alarm. These items are input by referring to an image projected onto the display unit 3 through the key operation of the remote controller 9 as an input means. The alarm generates such a sound as to call the user's attention and to carry out a report by utilizing the speaker 4. In place of the built-in speaker 4, another sound source such as a buzzer may be provided to generate a sound therefrom.

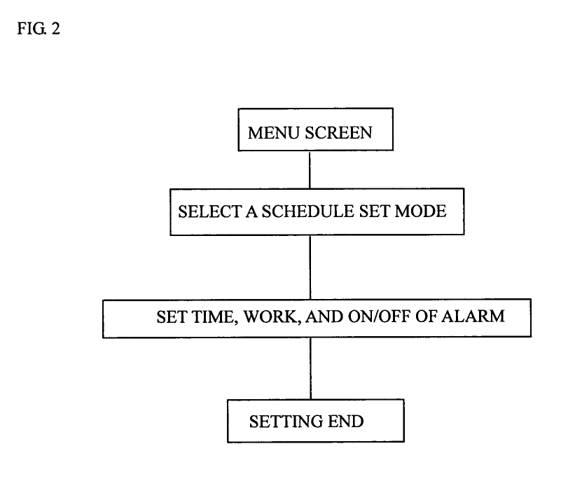

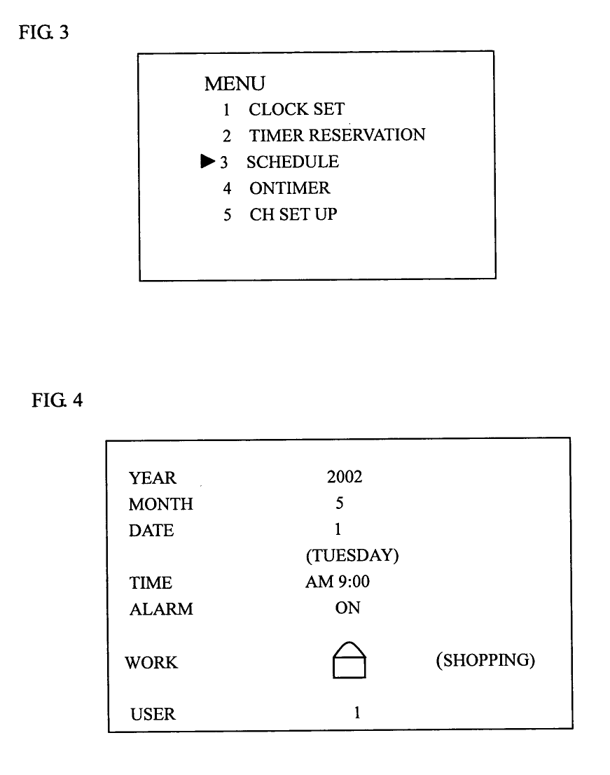

A procedure for inputting a schedule will be described with reference to FIG. 2. By the operation of the menu key of the remote controller 9, a menu screen mode is set to display a menu screen shown in FIG. 3 on the display section 3. “Schedule” is selected to set a schedule set mode. Since a schedule set screen is displayed, a date, a time, a work, presence of an alarm and a user's name are input. Each item is input by the operation of the numeric key of the remote controller 9. The work is input by characters or by selecting a mark or an icon of a pictorial character which is set for each work. For the user's name, an inherent number or mark assigned to each user is input or a name is input. The user's name is not a necessary item and does not need to be input.

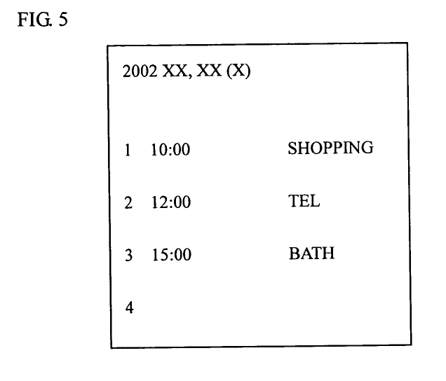

When each item is completely set as shown in FIG. 4, the information about the input schedule is saved in the memory 7. A plurality of schedules can be input and a list of the decided schedule on a certain day can be displayed as shown in FIG. 5. Moreover, the schedule can also be displayed for each week or month.

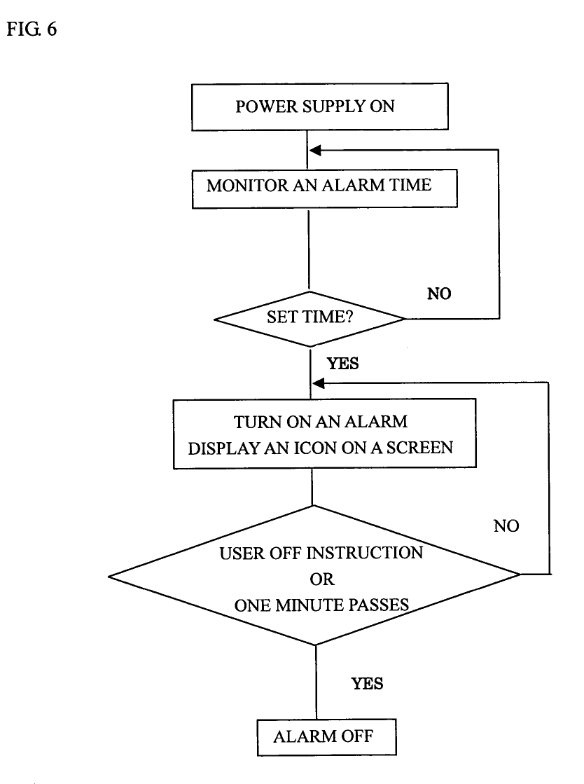

As shown in FIG. 6, it is monitored whether the input scheduled time comes based on a time sent from the timer 8. When the scheduled time comes, the alarm is turned ON and the information about the schedule is displayed on the display unit 3 if the alarm is set to “yes”. Thus, it is possible to inform the user of the schedule by appealing to the user's eyes and ears. When the alarm is set to “no”, the alarm is turned OFF.

A sound is output as an alarm from the speaker 4. In this case, a sound to appeal the user's attention, for example, an alarm sound or a melody is output or the information about the schedule is converted into a voice to be output. Furthermore, different sounds are output depending on the user's name. For example, the alarm sound or the melody is set to each user or the voice of a male, a female or a child is set depending on the user.

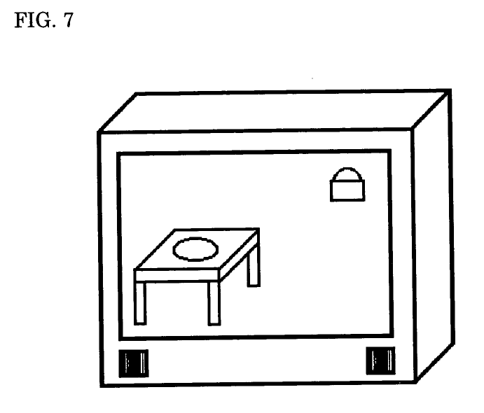

For the display, the image of an icon is synthesized and displayed on a part of a projected video or a character is displayed in place of the icon as shown in FIG. 7. Furthermore, a color is varied for display depending on the user's name.

The display and alarm is carried out for a set time, for example, one minute. When one minute passes, the alarm is turned OFF and the display of the information about the schedule is ended. If the user inputs an OFF instruction by using a key before the set time passes, the ending can be carried out immediately.

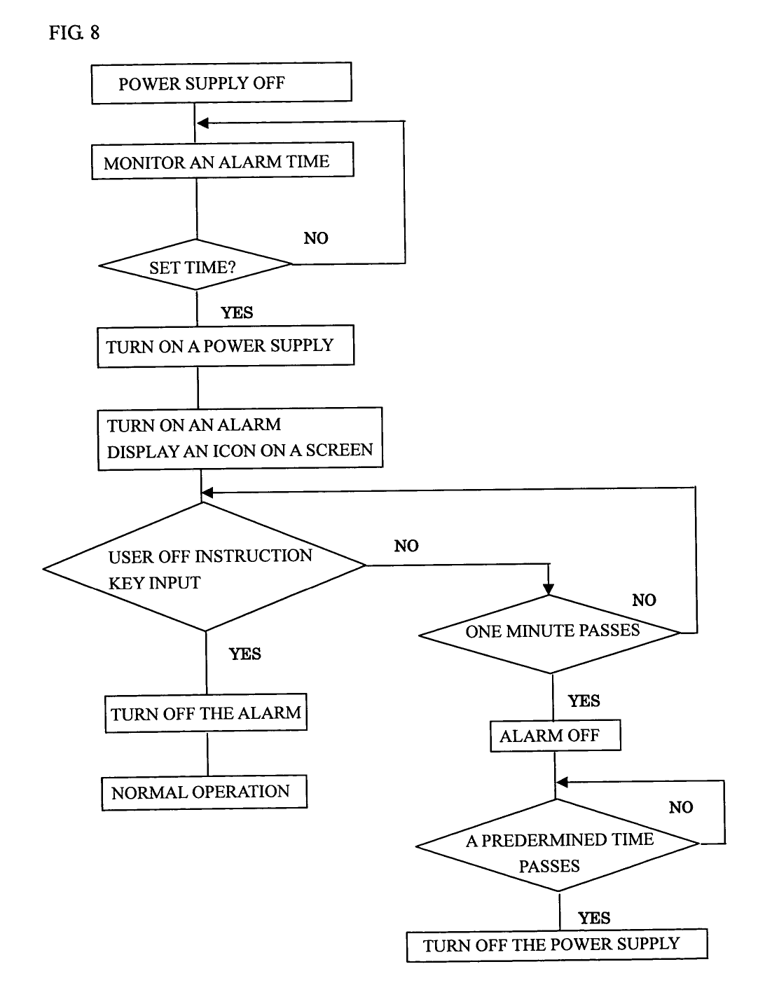

In the case in which the power supply of the television receiver is OFF, the display unit 3 and the speaker 4 are not operated. Also in the case in which the power supply is OFF, the control unit 6 is operated and the scheduled time is monitored based on the time sent from the timer 8 as shown in FIG. 8. When the scheduled time comes, the power supply is turned ON to activate the display unit 3 and the speaker 4. Subsequently, a report is carried out by the display and alarm in the same manner as described above.

When the user inputs the OFF instruction by using the key, the display and alarm is ended. Then, a normal operation is started. More specifically, a video is continuously projected as it is.

When the user does not carry out the input by using the key, there is a possibility that the user might be absent. When a set time, for example, one minute passes, consequently, the display and alarm is ended. When a predetermined time passes without the key input, furthermore, the power supply is turned OFF. Even if the user is absent, accordingly, the power supply can be automatically turned OFF to prevent wasteful power consumption.

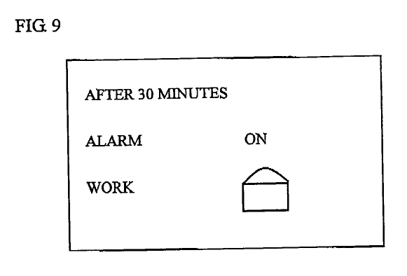

Moreover, the time of the timer 8 is input in place of a date and a time in the input of the schedule for simple setting to display the schedule. As shown in FIG. 9, the time of the timer 8 can be input and other inputs are carried out in the same manner as described above. The time of the timer 8 is selected from predetermined times or is set by inputting an optional time.

Timing is started when the schedule is completely set. When the set time of the timer 8 is reached, the alarm is turned ON and the information about the schedule is displayed on the display unit 3. When the time of the timer 8 is reached, the power supply is turned ON if it is OFF. Other operations are the same as described above. Since the setting can be thus carried out easily, a great deal of time and labor is not required for the setting when a work is to be carried out after the passage of a short time and a time is not wasted.

It is a matter of course that the present invention is not restricted to the embodiment but many modifications and changes can be made to the embodiment without departing from the scope of the present invention. For the input means, a private key for a schedule may be provided in the television receiver to directly carry out an input. Moreover, a communicating function may be added to the television receiver to input a schedule by wire or wireless from an external apparatus such as a personal computer or a portable information terminal. In place of the input through a key operation, a memory for recording a voice is provided to input the voice, and a schedule is not displayed but reported in a voice. If a remote controller having a built-in timer is used for a report by an alarm, a sound may be produced from the remote controller or the remote controller may be vibrated to carry out the report.

As is apparent from the above description, according to the present invention, also while a video is being projected, a display and an alarm are used together to report the presence of a schedule. Even if a user is absorbed in the video, therefore, a user can reliably confirm the schedule when a scheduled time comes. Thus, it is possible to prevent the execution of the schedule from being forgotten.

By utilizing a television receiver to be often used in a general life, accordingly, it is possible to manage a schedule without carrying out a complicated operation. It is sufficient that software is simply changed for an existing television receiver, and everybody can easily manage the schedule. Thus, it is possible to readily enhance the value added to the television receiver.

What is claimed is:

1. A television receiver comprising input means for inputting a schedule, alarm setting means for setting ON/OFF of an alarm, display means for displaying information about the schedule at a scheduled time, and reporting means for carrying out a report by the alarm at the scheduled time when the alarm is ON.

2. A television receiver comprising input means for inputting a schedule, alarm setting means for setting ON/OFF of an alarm, display means for displaying information about the schedule at a scheduled time, reporting means for carrying out a report by the alarm at the scheduled time when the alarm is ON, and starting means for turning ON a power supply when the power supply is OFF at the scheduled time.

3. A television receiver comprising input means for inputting a schedule, alarm setting means for setting ON/OFF of an alarm, display means for displaying information about the schedule at a scheduled time, reporting means for carrying out a report by the alarm at the scheduled time when the alarm is ON, starting means for turning ON a power supply when the power supply is OFF at the scheduled time; and ending means for turning OFF the power supply when a predetermined time passes after the power supply is turned ON.

4. The television receiver according to any of claims 1 to 3, further comprising timer means for carrying out timing after inputting a schedule, the display means displaying the information about the schedule when a time set at the time of the input of the schedule passes and the reporting means carrying out a report by the alarm when the alarm is ON and the time passes.
